(19) United States
(12) Patent Application Publication
(10) Pub. No.: US 2012/0023135 A1
(43) Pub. Date: Jan. 26, 2012

(54) METHOD FOR USING VIRTUAL FACIAL EXPRESSIONS

(76) Inventors: Erik Dahlkvist, Stockholm (SE); Martin Gumpert, Stockholm (SE); Johan Van Der Schoot, Bromma (SE)

(21) Appl. No.: 13/262,328

(22) PCT Filed: Oct. 29, 2010
(86) PCT No.: PCT/US10/54605

§ 371 Date: Sep. 30, 2011

Related U.S. Application Data
(60) Provisional application No. 61/260,028, filed on Nov. 11, 2009.

(51) Int. Cl. G06F 17/30

(52) U.S. Cl. 707/776; 707/E17.023

(57) ABSTRACT

The method is for using a virtual face. The virtual face is provided on a screen associated with a computer system having a cursor. A user manipulates the virtual face with the cursor to show a facial expression. The computer system determines coordinates of the facial expression. The computer system searches for facial expression coordinates in a database to match the coordinates. A word or phrase is identified that is associated with the identified facial expression coordinates. The screen displays the word to the user. The user may also feed a word to the computer system that displays the facial expression associated with the word.

### TECHNICAL FIELD

The invention relates to a method for using virtual facial expressions.

### BACKGROUND OF INVENTION

Facial expressions and other body movements are vital components of human communication. Facial expressions may be used to express feelings such as surprise, anger, sadness, happiness, fear, disgust and other such feelings. For some there is a need to train to better understand and interpret those expressions. For example, sales man, police and others may benefit from being able to better read and understand facial expressions. There is currently no effective method or tool available to train or study the perceptiveness of facial and body expressions. Also, in psychological and medical research, there is a need to measure subjects' psychological and physiological reactions to particular, predetermined bodily expressions of emotions. Conversely, there is a need to provide subjects with a device for creating particular, named emotional expressions in an external medium.

### SUMMARY OF INVENTION

The method of the present invention provides a solution to the above-outlined problems. More particularly, the method is for using a virtual face. The virtual face is provided on a screen associated with a computer system that has a cursor. A user may manipulate the virtual face with the cursor to show a facial expression. The computer system may determine coordinates of the facial expression. The computer system searches for facial expression coordinates in a database to match the coordinates. A word or phrase is identified that is associated with the identified facial expression coordinates. The screen displays the word to the user. It is also possible for the user to feed the computer system with a word or phrase and the computer system will search the database for the word and its associated facial expression. The computer system may then send a signal to the screen to display the facial expression associated with the word.

### BRIEF DESCRIPTION OF DRAWINGS

FIG. 1 is a schematic view of the system of the present invention;

FIG. 2 is a front view of a virtual facial expression showing a happy facial expression of the present invention;

FIG. 3 is a front view of a virtual facial expression showing a surprised facial expression of the present invention;

FIG. 4 is a front view of a virtual facial expression showing a disgusted facial expression of the present invention;

FIG. 5 is a front view of a virtual face showing a sad facial expression of the present invention;

FIG. 6 is a front view of a virtual face showing an angry facial expression of the present invention; and

FIG. 7 is a schematic information flow of the present invention.

### DETAILED DESCRIPTION

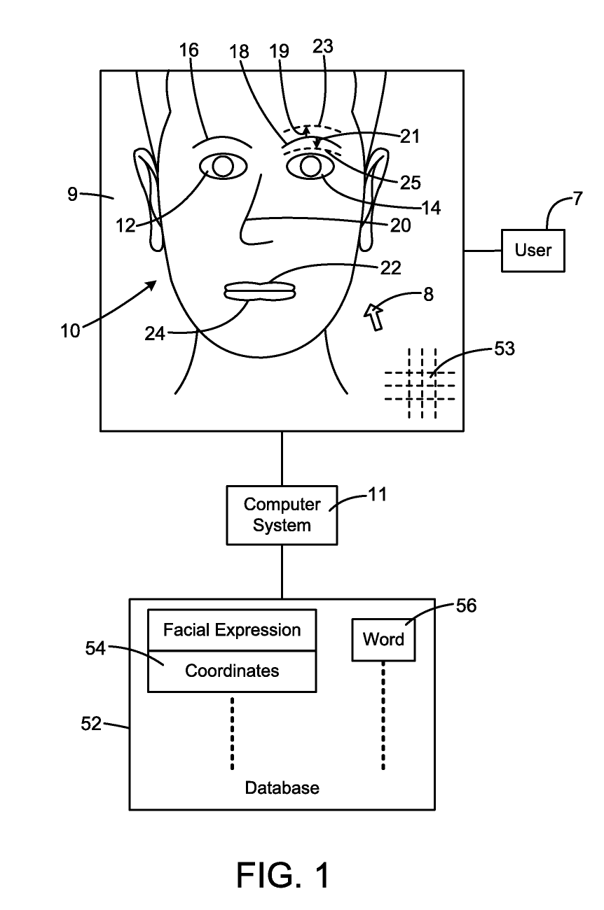

With reference to FIG. 1, the digital or virtual face 10 may be displayed on a screen 9 that is associated with a computer system 11 that has a movable mouse cursor 8 that may be moved by a user 7 via the computer system 11. The face 10 may have components such as two eyes 12, 14, eye brows 16, 18, a nose 20 an upper lip 22 and a lower lip 24. The virtual face 10 is used as an exemplary illustration to show the principles of the present invention. The same principles may also be applied to other movable body parts. A user may manipulate the facial expression of the face 10 by changing or moving the components to create a facial expression. For example, the user 7 may use the computer system 11 and point the cursor 8 on the eye brow 18 and drag it upwardly or downwardly, as indicated by the arrows 19 or 21 so that the eye brow 18 moves to a new position further away from or closer to the eye 14 as illustrated by eye brow position 23 or eye brow position 25, respectively. The virtual face 10 may be set up so that the eyes 12, 14 and other components of the face 10 also simultaneously change as the eye brows 16 and 18 are moved. Similarly, the user may use the cursor 8 to move the outer ends or inner segments of the upper and lower lips 22, 24 upwardly or downwardly. The user may also, for example, separate the upper lip 22 from the lower lip 24 so that the mouth is opened in order to change the overall facial expression of the face 10.

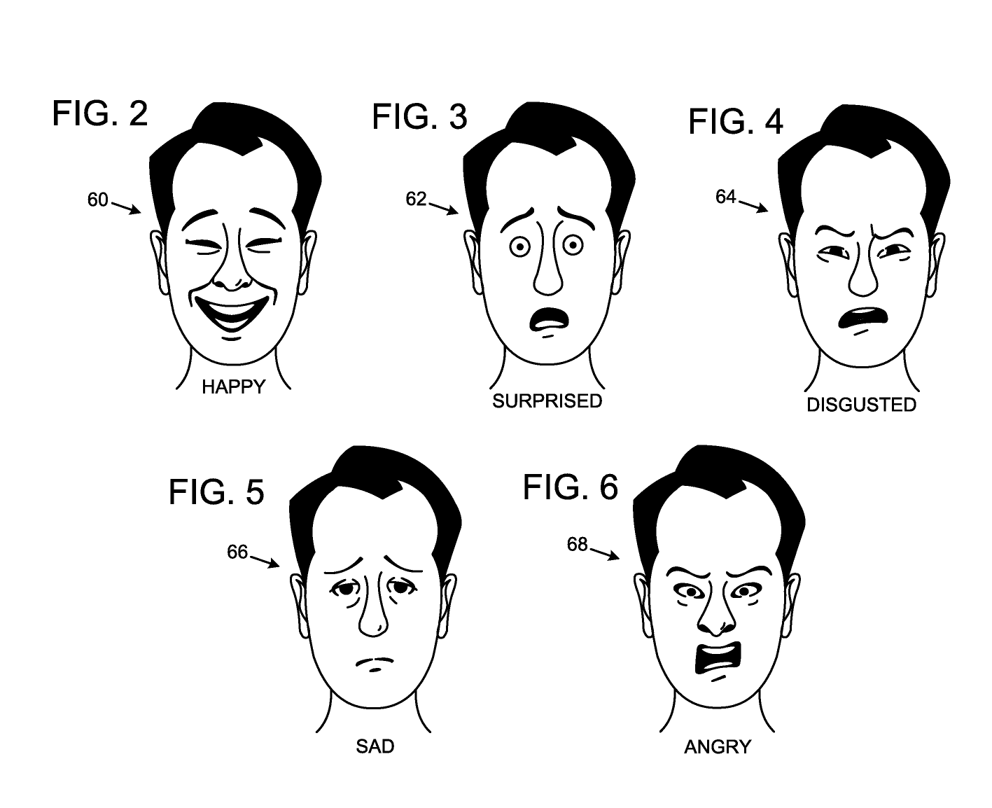

The coordinates for each facial expression 54 may be associated with a word or words 56 stored in the database 52 that describe the feeling illustrated by facial expressions such as happy, surprised, disgusted, sad, angry or any other facial expression. FIG. 2 shows an example of a happy facial expression 60 that may be created by moving the components of the virtual face 10. FIG. 3 shows an example of a surprised facial expression 62. FIG. 4 shows a disgusted facial expression 64. FIG. 5 shows a sad facial expression 66 and

FIG. 5 shows an example of an angry facial expression 68.

When the user 7 is complete with the manipulating, moving or changing of the components, such as the eye brows, the computer system 11 reads the coordinates 53 (i.e. the exact position of the components on the screen 9) of the various components of the face and determines what the facial expression is. The coordinates for each component may thus be combined to form the overall facial expression. It is possible that each combination of the coordinates of the facial expressions 54 of the components may have been pre-recorded in the database 52 and associated with a word or phrase 56. The face 10 may also be used to determine the required intensity of the facial expression before the user will see or be able to identify a certain feeling, such as happiness, expressed by the facial expression. The user's time of exposure may also be varied and the number or types of facial components that are necessary until the user can identify the feeling expressed by the virtual face 10. As indicated above, the computer system 11 may recognize words communicated to the system 11 by the user 7. By communicating a word 56 to the system 11, the system preferably searches the database 52 for the word and locates the associated facial expression coordinates 54 in the database 52. The communication of the word 56 to the system 11 may be orally, visually, by text or any other suitable means of communication. In other words, the database 52 may include a substantial number of words and each word has a facial expression associated therewith that have been pre-recorded as pamphlets based on the positions of the coordinates of the movable components of the virtual face 10. Once the system 11 has found the word in the database 52 and its associated facial expression, the system sends signals to the screen 9 to modify or move the various components of the face 10 to display the facial expression associated with the word. If the word 56 is “happy” and this word has been pre-recorded in the database 52 then the system will send the coordinates to the virtual face 10 so that the facial expression associated with “happy” will be shown such as the happy facial expression shown in FIG. 2. In this way, the user may interact with the virtual face 10 of the computer system 11 and contribute to the development of the various facial expressions by pre-recording more facial expressions and words associated therewith.

It is also possible to reverse the information flow in that the user may create a facial expression and the system 11 will search the database 52 for the word 56 associated with the facial expression that was created by the user 7. In this way, the system 11 may display a word once the user has completed the movements of the components of the face 10 to create the desired facial expression. The user may thus learn what words are associated with certain facial expressions.

It may also be possible to read and study the eye movements of the user as the user sees different facial expressions by, for example, using a web camera. The user's reaction to the facial expressions may be measured, for example the time required to identify a particular emotional reaction. The facial expressions may also be displayed dynamically overtime so illustrate how the virtual face gradually changes from one facial expression to a different facial expression. This may be used to determine when a user perceives the facial expression changing from, for example, expressing a happy feeling to a sad feeling. The coordinates for each facial expression may then be recorded in the database to include even those expressions that are somewhere between happy expressions and sad expressions. It may also be possible to just change the coordinates of one component to determine which components are the most important when the user determines the feeling expressed by the facial expression. The nuances of the facial expression may thus be determined by using the virtual face 10 of the present invention. In other words, the coordinates of all the components, such as eye brows, mouth etc., cooperate with one another to together form the overall facial expression. More complicated or mixed facial expressions, such as a face with sad eyes but a smiling mouth, may be displayed to the user to train the user to recognize or identify mixed facial expressions.

By using the digital facial expression of the present invention, it may be possible to enhance digital messages such as SMS or email with facial expressions based on words in the message. It may even be possible for the user himself/herself to include a facial expression of the user to enhance the message. The user may thus use a digital image of the user's own face and modify this face to express a feeling with a facial expression that accompanies the message. For example the method may include the step of adding a facial expression to an electronic message so that the facial expression identifies a word describing a feeling in the electronic message and displaying the feeling with the virtual face.

Cultural differences may be studied by using the virtual face of the present invention. For example, a Chinese person may interpret the facial expression different from a Brazilian person. The user may also use the user's own facial expression and compare it to a facial expression of the virtual face 10 and then modify the user's own facial expression to express the same feeling as the feeling expressed by the virtual face 10.

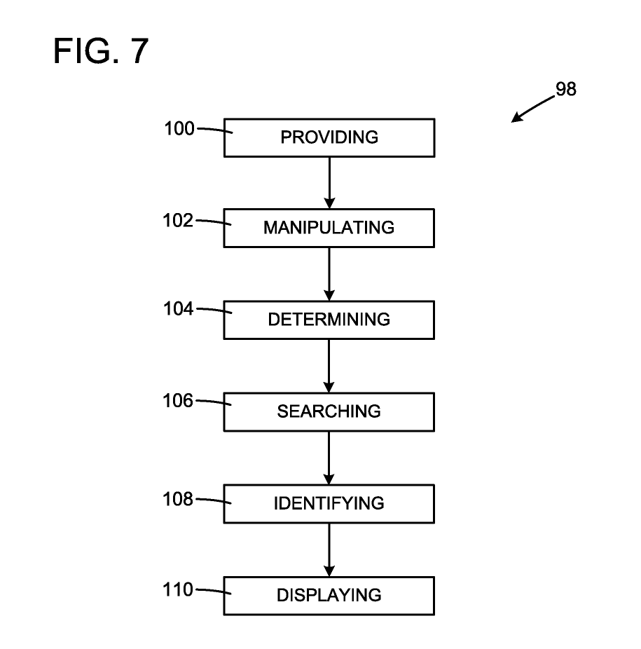

FIG. 7 illustrates an example 98 of using the virtual face 10 of the present invention. In a providing step 100, the virtual face 10 on the screen 9 associated with the computer system 11. In a manipulating step 102, the user 7 manipulates the virtual face 10 by moving components thereon such as eye brows, eyes, nose and mouth, with the cursor 8 to show a facial expression such as a happy or sad facial expression. In a determining step 104, the computer system 11 determines the coordinates 53 of the facial expression created by the user. In a searching step 106, the computer system 11 searches for facial-expression coordinates 54 in a database 52 to match the coordinates 53. In an identifying step 108, the computer system 11 identifies a word 56 associated with the identified facial expression coordinates 54. The invention is not limited to find just identifying a word but other expressions such as phrases are also included. In a displaying step 110, the computer system 11 displays the identified word 56 to the user 7.

While the present invention has been described in accordance with preferred compositions and embodiments, it is to be understood that certain substitutions and alterations may be made thereto without departing from the spirit and scope of the following claims.

1. A method for using a virtual face, comprising:
providing a virtual face on a computer screen associated with a computer system having a cursor;
manipulating the virtual face with the cursor to show a facial expression;
the computer system determining coordinates of the facial expression;
the computer searching for facial expression coordinates in a database to match the coordinates;
identifying a word associated with the identified facial expression coordinates; and
displaying the word to the user.

2. The method according to claim 1 wherein the method further comprises the steps of pre-recording words describing facial expression in the database.

3. The method according to claim 2 wherein the method further comprises the steps of pamphlets of facial expression coordinates of facial expressions in the database and associating each facial expression with the pre-recorded words.

4. The method according to claim 1 wherein the method further comprises the steps of feeding the word to the computer system, the computer system identifying the word in the database associating the word with a facial expression associated with the word in the database.

5. The method according to claim 4 wherein the method further comprises the steps of the screen displaying the facial expression associated with the word.

6. The method according to claim 1 wherein the method further comprises the steps of training a user to identify facial expression.

7. The method according to claim 1 wherein the method further comprises the steps of adding a facial expression to an electronic message so that the facial expression identifies a word describing a feeling in the electronic message and displaying the feeling with the virtual face.
